(19) United States
(12) Patent Application Publication
(10) Pub. No.: US 2014/0095211 A1
(43) Pub. Date: Apr. 3, 2014

(54) SYSTEMS AND METHODS OF DATA MAPPING FROM MULTIPLE DEVICES FOR DRIVING PERFORMANCE PRODUCT SYSTEMS

(71) Applicants: Terje Gloerstad, Scottsdale, AZ (US); Kevin West, Phoenix, AZ (US); Paul Wise, Mesa, AZ (US)

(72) Inventors: Terje Gloerstad, Scottsdale, AZ (US); Kevin West, Phoenix, AZ (US); Paul Wise, Mesa, AZ (US)

(21) Appl. No.: 13/835,381

(22) Filed: Mar. 15, 2013

Related U.S. Application Data
(60) Provisional application No. 61/744,755, filed on Oct. 3, 2012.

(51) Int. Cl. G06Q 40/08

(52) U.S. Cl. CPC G06Q 40/08
USPC 705/4

(57) ABSTRACT

Systems and methods of normalizing and aggregating data from vehicle devices. In one embodiment, a method includes receiving data in a variety of message formats and from a variety of device and converting the data into a a standard message format for further processing. Another embodiment combines data readings into vehicle trips for further processing.

### CROSS REFERENCE TO RELATED APPLICATIONS

This application claims priority to, and the benefits of, U.S. provisional application Ser. No. 61/744,755 filed on Oct. 3, 2012, which is incorporated by reference herein in full.

### BACKGROUND

Insurance-based driving performance products, such as, usage-based insurance and/or risk management for self-insurance, may rely on collecting and managing data associated with vehicle operation characteristics. In some situations, particular and reliable vehicle operation information is desired as a component of providing the insurance-based driving performance products, including from multiple types of data gathering devices.

The following patent applications are incorporated by reference herein in full: U.S. provisional application Ser. No. 61/749,600 and U.S. provisional application Ser. No. 61/762,547.

### SUMMARY

In one embodiment, a method of normalizing data from vehicle devices, the method including receiving a first data message in a first message format from a first device, receiving a second data message in a second message format from a second device, wherein the second message format is different than the first message format, converting the first data message into a first standard message in a standard message format, and converting the second data message into a second standard message in the standard message format.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 is a chart showing an exemplary insurance platform;

FIG. 2 is a flowchart/block diagram showing exemplary message handling associated with receiving and normalizing data from various exemplary devices; and

FIG. 3 is a flowchart showing exemplary steps associated with an exemplary data aggregation routine;

FIG. 4 includes an exemplary depiction of exemplary communication protocols and exemplary devices containing the systems and executing the processes.

### DESCRIPTION

The following includes definitions of exemplary terms used throughout the disclosure. Both singular and plural forms of all terms fall within each meaning:

“Address”, as used herein, includes but is not limited to one or more e-mail addresses, a distribution list including one or more e-mail addresses, uniform resource locator (URL) and file transfer protocol (FTP) locations or the like, network drive locations, a postal address, a combination of an e-mail address and a postal address, or other types of addresses that can identify a desired destination.

“Computer Readable Medium”, as used herein, includes but is not limited to any memory device, storage device, compact disc, floppy disk, or any other medium capable of storing data temporarily and/or permanently that can be interpreted by a computer.

“Device”, as used herein, includes any machine or component that attaches to and/or communicates with a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands.

“Game”, as used herein, includes any game-based or game-like activity, including interfaces, presentation of game objectives, results, gamified business processes, and gamified business functions. “Gamification” includes game-based experiences that include the use of game mechanics to present information, interfaces, objectives, feedback, products and/or services from business partners, etc., including outside of the realm of playing a game.

“Integrated Circuit” (“IC”), as used herein, includes, but is not limited to a small electronic device made out of a semiconductor material. Integrated circuits are used for a variety of devices, including microprocessors, audio and video equipment, and automobiles.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

“Network”, as used herein, includes but is not limited to the Internet, intranets, Wide Area Networks (WANs), Local Area Networks (LANs), and transducer links such as those using Modulator-Demodulators (modems).

“Platform”, as used herein, includes but is not limited to a computing system that combines hardware and software, including application frameworks. The platform may include a computer architecture, operating system, programming languages, and related user interfaces, including run-time system libraries and/or graphical user interfaces. Providing a “platform as a service” (PaaS) is a category of computing services that may provide an integrated platform with specific application solutions as a service, with various levels of scalability. Services may include providing specialized and/or customized hardware, such as, for example, networks, servers, storage, interface devices, etc., and software, such as, for example, applications, interfaces, security, etc. Hardware and/or software associated with the services may or may not be dedicated to one platform. Providing a PaaS may include development, testing, deployment, hosting, maintenance, updating, etc. A PaaS may include the capability to integrate with various outside and/or private systems, such as, for example, web services, databases, and networks, utilizing, for example, Simple Object Access Protocol (SOAP) and Representational State Transfer (REST) interfaces.

“Signal”, as used herein, includes but is not limited to one or more electrical signals, analog or digital signals, one or more instructions, a bit or bit stream, or the like. The term “command” is synonymous with “signal.”

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

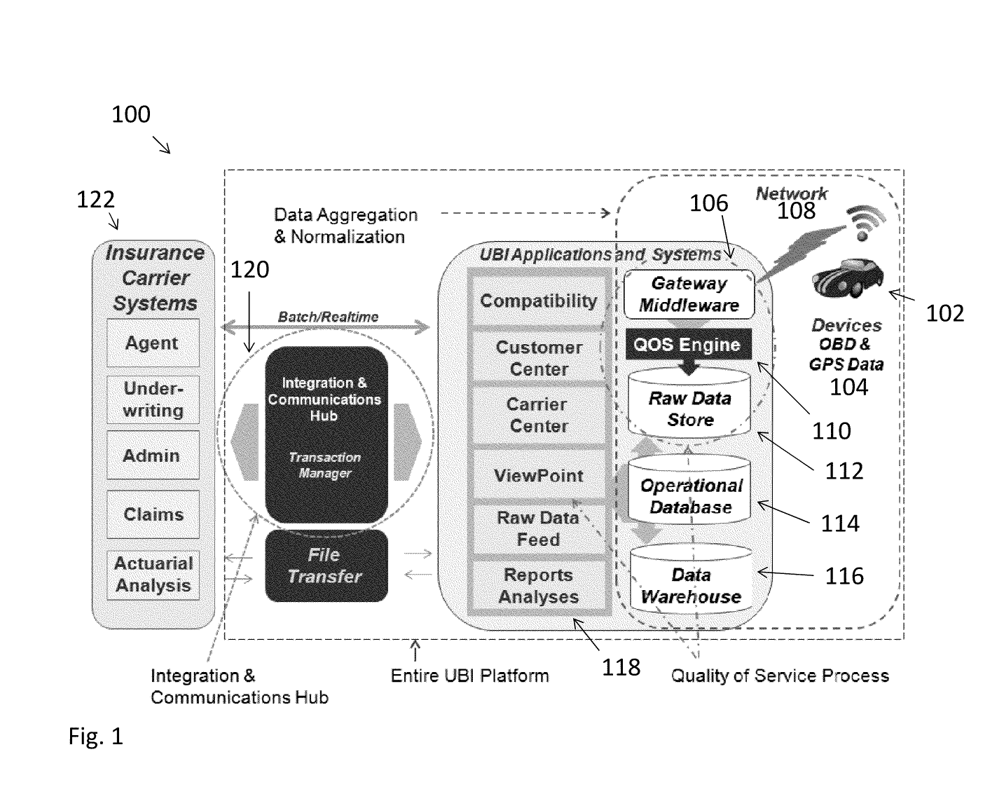

FIG. 1 shows an exemplary insurance support/enhancement platform 100, including exemplary hardware and software elements supporting carriers providing insurance, including, for example, usage-based insurance (UBI). As used herein, UBI includes usage-based insurance, behavior-based insurance (BBI), and other incentive or discount based insurance programs that may include use and behavior based elements including, for example, mileage, trips, driving performance and habits, geospatial data, etc. In other embodiments, the platform 100 may be associated with a driving performance product or application applicable to commercial/fleet management and/or self insurers. Clients of the platform or driving performance product may include insurance carriers, such as UBI carriers, commercial/fleet managers, self insurers, etc.

Insurers, for example, may be property/casualty insurance carriers that may use a driving performance product, such as a UBI product, for personal lines of insurance or commercial lines of insurance. Self-insurers, for example, may be companies with a large fleet that may self-insure an underlying layer of risk and may buy an umbrella layer of coverage over the self-insured layer. Self-insurers may use a driving performance product, such as a UBI product, that will allow them to gather the same data on drivers that an insurer tracks. Fleet managers, for example, may be companies with fleets of commercial vehicles and may have commercial insurance with a company that may not offer UBI, but they may be eligible for a discount from their insurance carrier if they employ a driving performance product, such as a UBI product, to monitor their drivers' performance. In other situations, fleet managers may use a driving performance product, such as a fleet management product (e.g., a subset of a UBI product), with features that allow them to track location, fuel consumption, hours of vehicle operation, etc.

A UBI product is an exemplary driving performance product. For simplicity, this application may refer to exemplary UBI products, programs, systems, features, transactions, etc. However, references to UBI are exemplary and include all of the exemplary driving performance products described above, among others.

As illustrated in this application, blocks or steps of flowcharts represent logic functions, actions and/or events performed therein. It will be appreciated by one of ordinary skill in the art that electronic and software systems involve dynamic and flexible processes such that the illustrated blocks and described sequences can be performed equivalently in different sequences or in parallel. It will also be appreciated by one of ordinary skill in the art that elements embodied as software may be implemented using various programming approaches such as, for example, machine language, procedural, object-oriented, or artificial intelligence techniques. It will further be appreciated by one of ordinary skill in the art that, if desired and appropriate, some or all of the software can be embodied as part of a device's operating system.

In the exemplary platform 100 of FIG. 1, data, such as, for example, latitude/longitude of a vehicle 102 is captured and/or transmitted, for example, wirelessly from a device 104, associated with the vehicle 102, such as a dongle device, on-board diagnostic (OBD) device, global positioning system (GPS) device, iOS or Android device, smart phone, tablet, or other telematics device to one or more gateways 106 via, for example, network 108. In other embodiments, GeoSpatial information can be added to latitude/longitude information, which can add additional information to the specific location. Time variable parameters may also be added such as weather as a function of time and place.

The data from the device 104 may include information associated with driving performance related to, for example, a UBI product, such as, for example, driving behavior, vehicle location, etc. In some embodiments, data captured and/or transmitted by the device 104 may include data from more than one data source or device. For example, the device 104 may transmit data captured from the vehicle 102 OBD device and/or data captured from a GPS system included in the device 104 or another device 104. Gateways 106 may include a device 104 manufacturer's or provider's gateway or a common gateway established for the platform 100. In some embodiments, data may be captured and/or transmitted directly from the vehicle 102, such that the vehicle 102 or a component of the vehicle 102 is the device 104. The device 104 may or may not be connected to the vehicle 102.

Data may be processed through a Quality of Service (QOS) application or engine 110, which can evaluate, for example, data packets and aggregated packets (e.g., trips) and can pass results through algorithms for data retention, display, and/or use. Resulting raw data can be stored in raw data store 112 and passed to an operational database 114 and data warehouse 116, which may allow some applications 118 (e.g., Carrier Center, Customer Center, ViewPoint, etc.) to access the data directly and/or other applications (e.g., Actuarial Analysis) to access the data via, for example, File Transfer Protocol (FTP). An integration and communications hub 120 can manage transactions to and from other systems and applications, including, for example, the exemplary insurance carrier systems 122. These communications and transactions may include, for example, logistics for ordering the device 104, dashboards for viewing driving results as recorded by the device 104, processes for managing insurance rates, etc.

The insurance platform 100 may be created by, hosted by, and/or used by providers or those associated with providers of driving performance products, such as, for example, UBI.

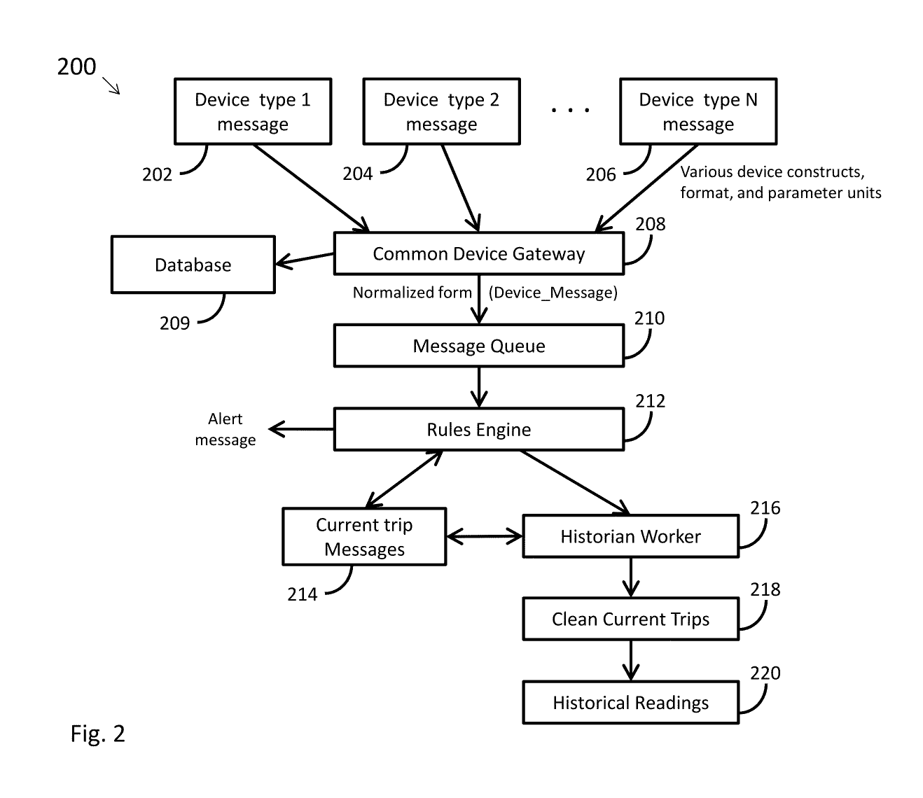

Referring to FIG. 2, and with further reference to FIG. 1, an exemplary multiple message format receiver/handler process 200, associated with collecting and normalizing data from various exemplary devices, is shown. Data associated with vehicle 102 operation may be collected from various devices 104 associated with the vehicle 102, devices 104 associated with the vehicle's driver, devices 104 associated with the vehicle's operating environment, or other devices 104 associated with various other vehicle-related operating conditions or events. As mentioned above, devices 104 may be integrated into the vehicle 102 by the Original Equipment Manufacturer (OEM), such as, for example, OBD II and GPS devices. Other devices 104 include aftermarket devices that may include similar or additional capabilities. Any of these devices 104 may include the capability to generate data associated with vehicle 102 location, operation (e.g., ignition ON/OFF, speed, acceleration, braking, heading, etc.), environment (e.g., weather), time of day, etc. In some embodiments, devices 104 may cooperate with other devices, including other devices 104, to generate data, including, for example, aftermarket devices that cooperate with OEM devices to generate data. In some embodiments, multiple devices 104 associated with the same vehicle 102 may be connected, including wired or wirelessly, or not connected. In other embodiments, multiple devices 104 may generate data associated with the same location, characteristic, operation, event, etc.

The insurance platform 100 host may also provide device 104 management, which may include, for example, all of the activities required to get a device 104 up and running with a particular vehicle 102 and/or driver/customer. In one embodiment, the device 104 may be inert until it's connected to a subscriber identification module (SIM) card tracking device (e.g., phone number connects to a cell network that allows device 104 to operate) and is activated on a network 108. Next, the device 104 and SIM card may be matched to a vehicle 102, so that the host (e.g., associated with a carrier) knows what vehicle 102 the data received from the device 104 relates to.

In another embodiment, the platform 100 host may also design firmware for the device 104 and provide it to a device 104 manufacturer, using specifications established by an actuarial consultant or a carrier's actuary. If an external actuary is used, the carrier may agree to allow it access to aggregate data, to build a more robust data set quickly. The device 104 may collect data associated with a range of parameters. In one embodiment, data may be gathered into packets of information, called “HistoricalReadings.” In one embodiment, for example, the device 104 may collect data associated with any of the following: (exemplary treatment of the data, for example, by a QOS engine 110, is also shown after the exemplary data parameters)
Number of satellites accessed (GPS_FIX). An average of 7 satellites may be considered good. Two conditions are flagged: # of satellites is <3 (GPS_FIX_0) OR # of satellites=3 or 4 (GPS_FIX_1).
HDOP: horizontal dilution of precision. An HDOP below 12 may be considered good. Two conditions are flagged: HDOP≧20 (HDOP_0) OR HDOP>12 and <20 (HDOP_1).
Unit status documents tests of the performance of the GPS unit, GPS antenna, modem and modem antenna. The performance may be measured periodically, such as, for example, once per second. A flag is set if any device-specific failure codes are present. (UNIT_STATUS)
Missing or unusable location from GPS. Based on calculated speed between two latitudes and longitudes reported Miles per Hour (MPH), two conditions are flagged: MPH>200 (SPEED_0) OR MPH>120 and ≦200 (SPEED_1). A flag is also set if latitude or longitude=0.0, indicating bad coordinates (BAD_COORD).
Timestamp. Each packet includes a GPS timestamp. An flag may be set if the timestamp<2011-01-01 or >the time of QoS processing (SUSPECT_TIME).
Speed. Suspect readings are flagged is GPS speed≧200 mph (SPEED_0) OR speed is ≧120 mph and <200 MPH (SPEED_1).
OBD/GPS speed comparison. Speed may be captured from both the GPS and dongle device every second. When the speed comparison is calculated, flags are set if the difference between the two readings is >23 MPH (SPEED_CMP_0) OR the difference is >7 and ≦23 MPH (SPEED_CMP_1).
Idle. A flag is set if OBD speed<1 MPH and GPS speed is <3 MPH (IDLE).
Duplicate latitude/longitude. A reading may only be flagged when the adjacent reading contains any of [BAD_{—}COORD|SPEED_0|SPEED_1|SPEED_{—}CMP_0|SPEED_{—}CMP_1|GPS_{—}DUP_{—}POS].
Multiple bad readings. A flag is set if <7 consecutive seconds of DISPLAYABLE readings are captured. Called “guilt by association.” (GBA)
Change in velocity over time (DVDT). A flag is set if the vehicle speed should change less than 24 mph per second.
Dropout. A flag is set when a combination of readings indicates the device is “dropping” data or is otherwise non-reporting. (OBD speed=0.0 & GPS speed !IDLE)∥(OBD speed !IDLE & GPS speed=0.0)∥(IDLE & last reading=DROPOUT)
Start Location compares the first ‘good’ trip reading to the last trip's last reading. Indicators are set for 4 levels of location variation ranging from >100 feet to >30 miles.

In other embodiments, additional readings or combinations of readings may also be developed as new insights are created.

In another embodiment, device 104 management may also include, for example, providing the configured device 104 to a customer, labeled for a specific vehicle 102, with a SIM card attached to the device 104. When the device 104 is coupled to the vehicle 102, and successfully transmitting data, the device 104 may be confirmed by the platform 100, for example, via the carrier center 118. If a device 104 is sent, but never confirmed, the host may follow up, for example, using logic built into the integration and communications hub 120 and carrier center 118.

In another embodiment, device 104 management may also include, for example, customization of the device 104 via an activated SIM card. Devices 104 may consist of various hardware components, such as, for example, a GPS receiver, a cellular modem, accelerometer(s), an OBD reader, a memory, a microprocessor, firmware, reporting configurations, etc. In one embodiment, the device 104 may be reprogrammed Over the Ait (OTA). In one embodiment, the host, for example, may modify the firmware and/or reporting configurations. This can enable the device 104 to be configured for different product specifications set by a host (e.g., to a carrier's specifications). For example, specifications may vary based on rating factors allowed in each state, as well as actuarial analysis of factors by each carrier.

Referring back to FIG. 2, the devices 104 may also include various different types of devices 104, including up to N types, as shown in FIG. 2. In this example, “N” represents devices 104 of unlimited number and type. Each device 104 may communicate using its own message protocol. For example, the devices 104 may have different message constructs, formats, and parameter units. As shown in FIG. 2, exemplary messages 202, 204, 206, originate from devices 104 of different types: type 1, type 2, . . . , type N.

Messages 202, 204, 206, may be sent to a server, such as, the common device gateway 208. The gateway 208 is a server that can record binary data sent from the various N devices 104. In various embodiments, data may be sent to the gateway 208 wirelessly in real-time, near real-time, or may be delayed. In other embodiments, data may be stored locally or remotely for future communication to the gateway 208. Each device 104 can connect to the gateway 208 through a socket that may be unique to the protocol of the device 104. The gateway 208 can convert the data into a normalized or standardized form (e.g., Device_Message), hereafter referred to as a DeviceMessage. The DeviceMessages are in a standard format for storage and/or use by subsequent process. For example, device type 1 messages 202 may record heading in a short integer, where each value represents one degree and device type 2 messages 204 may record heading in a byte where each value represents 1.40625 degrees. The resulting DeviceMessage from both devices, as provided by the gateway 208, will represent heading as an integer, where each value represents one degree. A DeviceMessage can be converted back into its original binary form with only a minor loss in data. Converting data back into its original form may be useful for replaying trips.

Unit conversions can take place in the gateway 208 during message normalization. Normalization can allow the gateway 208 to be device 104 agnostic. In this manner, the data can be used as if it has come from a single device 104. The gateway 208 not only interprets data, but creates a single form of data from among many devices 104, for example, that carriers can use for analysis and product design. In another embodiment, data compression can be enabled between the device 104 and the gateway 208. Different algorithms can be used depending on the performance needed and the level of device 104 support. In one embodiment, the data stream may be compressed on the device 104, and then decompressed in the gateway 208, saving transmission/storage costs. The compression will normally be loss-less.

Data may also be segmented and access protected. In one embodiment, an actuarial process, part of 122, will have access to all data, including all readings via web services or a FTP site. The customer center, part of 118, may have access to trip summary information that may be stored for more than one year in a database. In one embodiment, the readings may be stored in a database for less than one year before being moved to long term storage.

The gateway 208 can transport each DeviceMessage to a message queue 210. In another embodiment, the gateway 208 may transport each DeviceMessage to a database 209. A DeviceMessage can be marshaled or assembled into a self-describing binary form, consisting of meta field “fields”, followed by zero or more fields. “Fields” is an implicitly ordered bit set that indicates which fields are present. The fields value can be an ordered bit set that indicates how to interpret the bits that follow. In particular, starting at the least significant bit, if the bit is present the deserializing code will pull the corresponding field from the binary stream. For example, in one embodiment, when bit one is flagged, it means the device ID string is the next data in the binary stream. Each bit position represents a unique field, and each field has an implicit type. Most integer values, including the first field, are stored in a variable-byte format that uses one to nine bytes. Small values can be stored in a single byte. The first byte indicates the number of bytes, and it also contains data for small values. In addition, where the gateway 208 persists the DeviceMessages is configurable. In particular, the gateway 208 can be configured to write the DeviceMessages to different persistent stores (e.g. message queue, file system, database, etc.). In other embodiments, the gateway 208 can write data directly to the database 209 or to files. However, regardless of the destination or storage location of the data, a key aspect of the gateway 208 is that it normalizes each message and then pushes the data to a location for some other process to use.

The variable-byte format mentioned above may consists of a byte that indicates how the data is packed followed by zero or more bytes. The first byte also contains data when the integer is positive and less than 16,384. For example:

| First Byte | Range | Bytes |
|---|---|---|
| 0XXXXXXX | 0 . . . 127 | 1 |
| 10XXXXXX | 128 . . . 16383 | 2 |
| 111XXXXX | 0x8000000000000000 . . .−1, | 2.9 |
| | 16384 . . . 0x7FFFFFFFFFFFFFFF | |

When the first byte has 0xE in positions five through seven, the following applies: Position four will be flagged when the value is negative. Negative values are converted using two's complement. Positions zero through three indicate the number of bytes that follow. For example:
0x01=1
0x8100=256
0xE3010000=65536
0xF101=−1

As mentioned above, a DeviceMessage is marshaled or assembled into a self-describing binary form. In particular, a DeviceMessage object has setter methods that add the corresponding MessageField to the fields ordered set. For example, invoking message.setDeviceId (“123”) adds MessageField.DEVICE_ID to fields and stores “123” in an instance variable. Each MessageField has a FieldType that determines how the value is read from and written to a binary buffer. MessageField.DEVICE_ID has a FieldType of STRING, so the binary form of the attribute will contains a variable-length integer that indicates the number of bytes, and a sequence of UTF-8 bytes. The gateway 208 serializes a message by writing the fields attribute to a byte buffer, and then writing each MessageField, in the order it occurs, to the buffer using the type's FieldType. A message is deserialized by reading the MessageField set from the buffer and using the FieldType of each MessageField to read the rest of the data. For example:

DeviceMessage m = new DeviceMessage( );
m.setUpdateTime(2);
m.setGpsSpeed(1);
// m.fields contains { MessageField.FIELDS,
MessageField.GPS_SPEED, MessageField.UPDATE_TIME }
byte[ ] bytes = m.marshal( );
// bytes contains (in hex): 81110000000201
// fields: 0x8111
// updateTime: 0x00000002
// gpsSpeed: 0x01

A (nominal) rules engine 212 can pull each message off of the message queue 210 and associate it with a specific device 104 using the device ID. In addition, a CurrentReading can be associated with a CurrentTrip, as discussed in more detail below. In one embodiment, if a user has activated an alert feature, the engine 212 can check a message's coordinates and timestamp for violations associated with the alert and can send a communication, such as, for example, an email message, to the user if any violations are found. The device's current engine state (e.g., whether the ignition is on or off) can be stored in a CurrentTrip database 214 record. The engine 212 checks whether the newest message changes the engine's state and it notifies a historian worker 216 if the state has changed. The historian worker 216 can aggregate the normalized data.

The historian worker 216 waits for notifications from the rules engine 212. Once notified, the historian worker 216 cleans the current trips at 218. For example, the historian worker 216 retrieves the messages from the database 214, groups them into completed trips by engine state transitions, removes duplicate messages (if any), and processes the completed trips. The historian worker 216 can detect suspicious data, for example, by comparing each message with its neighbors, calculating statistics, updating the device 104 history, and storing the message in the historical reading database 220.

For example, in one embodiment, the historian worker 216 groups current readings into trips by engine state transitions. Engine state transitions are determined by the event, if present, of the DeviceMessage. Some events are allowed to occur when the engine is on or off. Only events that occur in one engine state or the other, but not both, are used to group trips. For example:

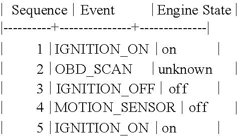

The above readings would be grouped into two trips: [1, 2, 3], and [4]. Reading 5 would remain a CurrentReading until the next reading with an engine state of off. In one embodiment, readings with a gap in the sequence number are assumed to be lost forever once more than 25 are missing. Duplicate readings may be detected and discarded, using the sequence number.

Some devices 104 may send many samples within the same packet. For example, a device 104 might send 30 1-second samples every 30 seconds. The historian worker can convert each sample in a DeviceMessage into a separate HistoricalReading before QOS processing and calculating statistics. Each HistoricalTrip and HistoricalReading may ultimately have a set of QOS flags that start out empty. The QOS rules involve first flagging each HistoricalReading, and then flagging the trip.

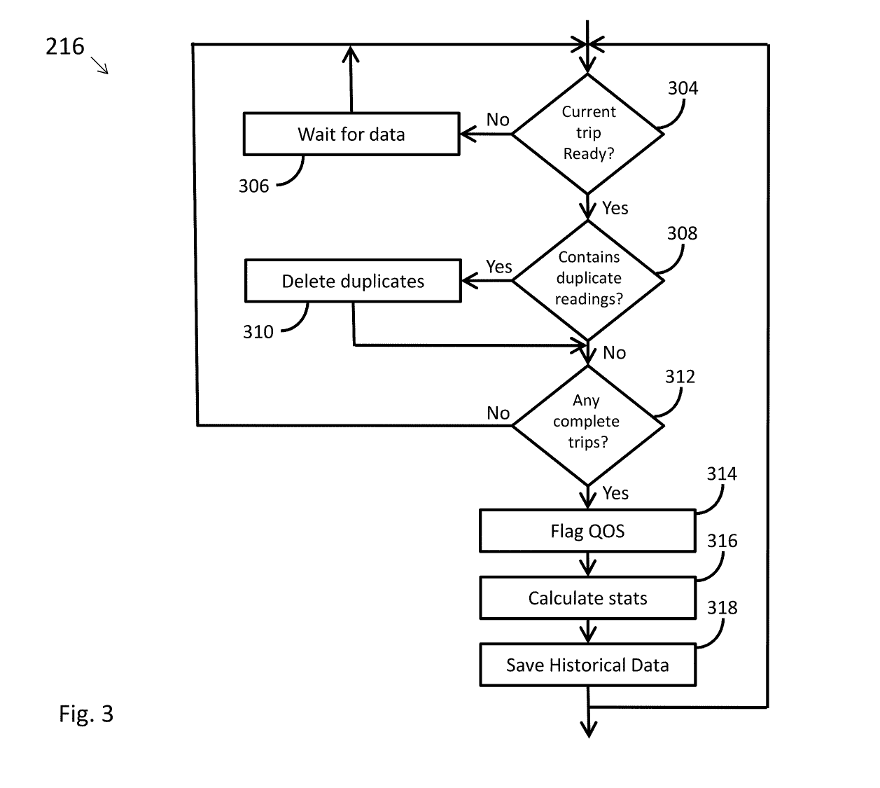

FIG. 3 shows an exemplary embodiment of a historian worker 216 process or routine, which may also include steps 218 and 220. The historian worker 216 starts at 304, where the historical worker 216 determines if a current trip is ready. If no, the routine proceeds to 306, where the routine waits for data and proceeds back to 304. If yes, the routine proceeds to 308, where the routine determines if the current trip contains duplicate readings. If yes, the routine proceeds to 310, where the routine deletes duplicates, and then proceeds to 312. If no, the routine proceeds directly to 312, where the routine analyzes the readings to determine if there are any complete trips, based on, for example, engine state transitions, as mentioned above. If no, the routine proceeds back to 304. If yes, the routine proceeds to 314, where the routine flags QOS.

After 314, the routine proceeds to 316, where the routine calculates statistics. For example, the historian worker 216 can derive driving events, such as, for example, acceleration, deceleration, and speeding events based on speed (e.g., OBD speed, if present, otherwise GPS speed can be used). Only readings with good QOS are used to derive driving events. For example, the historian worker 216 can record the time spent driving in rush hour traffic and the number of derived events in the HistoricalTrip.

After 316, the routine proceeds to 318, where the routine saves the historical data. After 318, the routine proceeds back to 304. In one embodiment, the data stored at 209, 214, 220, and 318 may be stored in the raw data store 112.

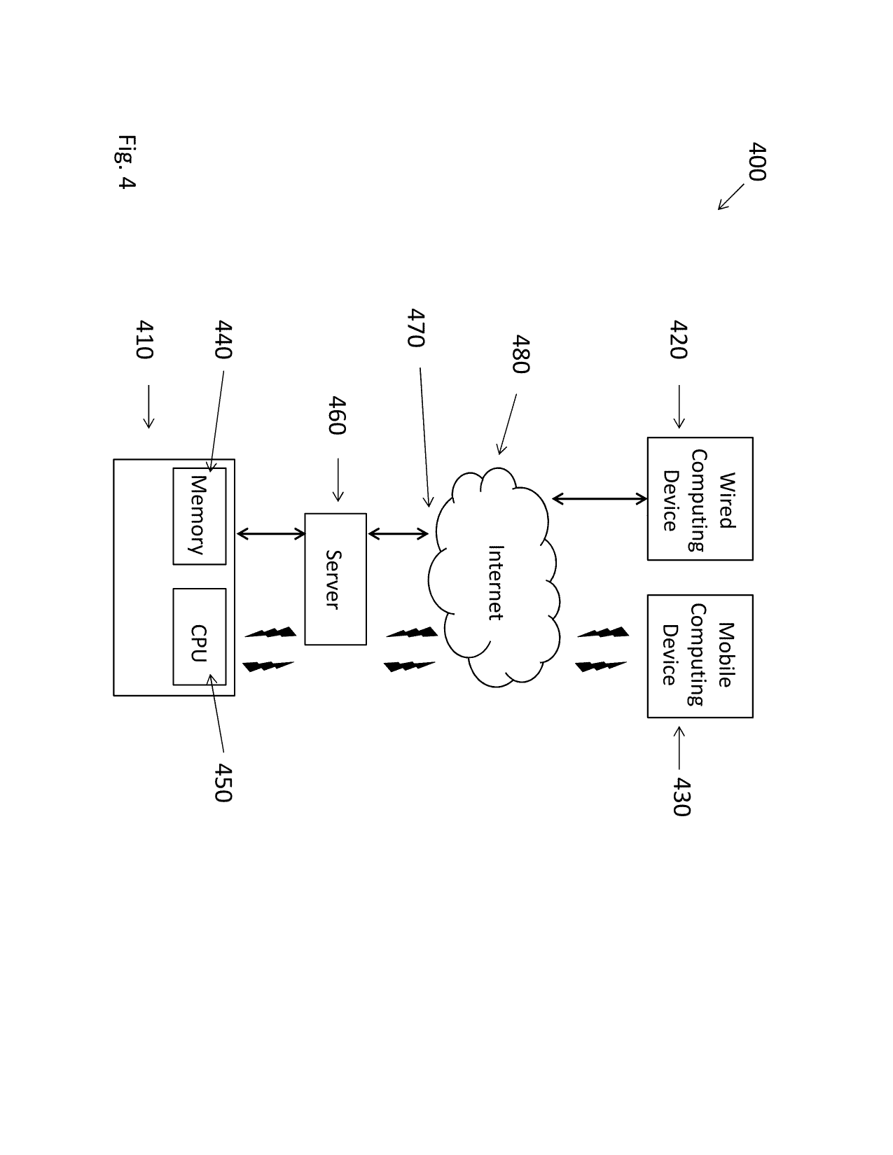

FIG. 4 includes an exemplary depiction of exemplary communication protocols and exemplary devices containing the platform 100 and/or processes 200, 216, and their associated applications. The devices can include the means for executing logic associated with the platform 100 and/or processes 200, 216, and their associated applications. The platform 100 and/or processes 200, 216 may be executed on a variety of computing devices 410, including, e.g., wired devices 420 (e.g., desktop computers) and mobile devices 430 (e.g., smartphones and tablets), kiosks, or any other device capable of hosting or presenting the platform 100 to a user with a display and input mechanism. The platform 100 and/or processes 200, 216 may be stored in the memory 440 of a device and processed by a Central Processing Unit (CPU) 450. The platform 100 and/or processes 200, 216 may be stored and accessed via the same device, stored remotely in a first device and accessed via a different second device, or any other combination thereof. The platform 100 and/or processes 200, 216 and/or their associated logic may be stored in local or remote memory (e.g., of a server 460), and accessible directly or via a network 470 (e.g., over the internet 480). The platform 100 and/or processes 200, 216 may also be a web-based application accessible via the internet 480. A database associated with the platform 100 and/or processes 200, 216 may be located in the same or different memory location than the platform 100 and/or processes 200, 216. Similarly, a database associated with the platform 100 and/or processes 200, 216 may be accessed the same way or differently than the platform 100 and/or processes 200, 216.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

1. A method of normalizing driving performance data from vehicle devices, the method comprising:
receiving a first data message in a first message format from a first device;
receiving a second data message in a second message format from a second device, wherein the second message format is different than the first message format;
converting the first data message into a first standard message in a standard message format; and
converting the second data message into a second standard message in the standard message format.

2. The method of claim 1, further comprising:
receiving a third data message in a third message format from a third device, wherein the third message format is different than the first message format and the second message format; and
converting the third data message into a third standard message in the standard message format.

3. The method of claim 1, wherein the first device and the second device are associated with a first vehicle.

4. The method of claim 3, wherein the first data message and the second data message are associated with a first parameter.

5. The method of claim 1, further comprising storing the first standard message and the second standard message in a database.

6. The method of claim 1, further comprising storing the first standard message and the second standard message in a queue for later processing.

7. The method of claim 1, wherein receiving a first data message comprises receiving the first data message through a first socket associated with the first device, and wherein receiving a second data message comprises receiving the second data message through a second socket associated with the second device.

8. The method of claim 1, wherein the first data message comprises compressed data, and the method further comprises decompressing the first data message.

9. The method of claim 1, wherein the standard message format comprises a self-describing binary form.

10. The method of claim 1, further comprising:
associating the first standard message with the first device; and
associating the second standard message with the second device.

11. The method of claim 1, further comprising aggregating the first standard message and the second standard message into a group of messages associated with a common trip.

12. A method of aggregating data from vehicle devices, the method comprising:
receiving a plurality of data messages associated with a vehicle;
analyzing the plurality of data messages to determine if the data messages are associated with a common trip; and
creating a first message group comprising a first subset of the plurality of data messages associated with a first trip.

13. The method of claim 12, further comprising creating a second message group comprising a second subset of the plurality of data messages associated with a second trip.

14. The method of claim 12, further comprising:
analyzing the plurality of data messages to determine if the data messages represent duplicative data; and
deleting one of the plurality of data messages if the one of the plurality of data messages is duplicative of another of the plurality of data messages.

15. The method of claim 12, wherein analyzing the plurality of data messages to determine if the data messages are associated with a common trip comprises analyzing engine state data, wherein data messages associated with one engine on state are associated with the common trip.

16. The method of claim 12, further comprising storing the first message group in a database.

17. The method of claim 12, further comprising storing the first message group in a queue for later processing.

18. The method of claim 12, wherein the plurality of data messages comprise normalized data messages.

19. A system for normalizing data from vehicle devices, comprising:
a computer system, comprising a memory and a processor, wherein the memory comprises logic for:
receiving a first data message in a first message format from a first device;
receiving a second data message in a second message format from a second device, wherein the second message format is different than the first message format;
converting the first data message into a first standard message in a standard message format; and
converting the second data message into a second standard message in the standard message format.

20. A computer readable medium comprising logic for:
receiving a first data message in a first message format from a first device;
receiving a second data message in a second message format from a second device, wherein the second message format is different than the first message format;
converting the first data message into a first standard message in a standard message format; and
converting the second data message into a second standard message in the standard message format.

21. A system for a game-based driving performance application, comprising:
means for receiving a first data message in a first message format from a first device means;
means for receiving a second data message in a second message format from a second device means, wherein the second message format is different than the first message format;
means for converting the first data message into a first standard message in a standard message format; and
means for converting the second data message into a second standard message in the standard message format.
